(19) United States
(12) Patent Application Publication
(10) Pub. No.: US 2024/0289877 A1
(43) Pub. Date: Aug. 29, 2024

(54) SYSTEMS AND METHODS FOR VALIDATING DYNAMIC INCOME

(71) Applicant: Capital One Services, LLC, McLean, VA (US)

(72) Inventors: Andrew Ricchuiti, Dallas, TX (US); James Dunlap, The Colony, TX (US); Josiah Gray, Grosse Pointe, MI (US)

(21) Appl. No.: 18/174,559

(22) Filed: Feb. 24, 2023

(51) Int. Cl. G06Q 40/02

(52) U.S. Cl. CPC G06Q 40/02

(57) ABSTRACT

Disclosed embodiments may include a method for validating dynamic income. The method may include receiving, via a first user device, estimated income amount associated with a customer, and receiving or retrieving a plurality of transactions comprising associated text data. The method further includes dynamically determining, using a first machine learning model, a repeating source of deposits by identifying from among the plurality of transactions a portion of the text data that repeats and corresponds to one or more credits, dynamically generating, using a second machine learning model, an income amount and a confidence score based on the repeating source of deposits and the estimated income amount, dynamically generating a graphical user interface comprising the income amount and the confidence score, and dynamically transmitting the graphical user interface to a second user device for display.

The disclosed technology relates to systems and methods for validating dynamic income. Specifically, this disclosed technology relates to generating and providing for display in a graphical user interface (GUI) an income amount and confidence score for a customer's income that is validated dynamically using optical character recognition (OCR) and machine learning models (MLM).

### BACKGROUND

To verify the income of a customer, it can be necessary to parse and analyze multiple transactions. This validation process can be timely and can take considerable resources depending on the number of customers, transactions, and bank statements.

Accordingly, there is a need for improved systems and methods for validating income dynamically. Embodiments of the present disclosure are directed to this and other considerations.

### SUMMARY

Disclosed embodiments may include a system for validating dynamic income. The system may include one or more processors, and memory in communication with the one or more processors and storing instructions that, when executed by the one or more processors, are configured to cause the system to validate dynamic income. The system may receive, via a first user device, estimated income amount associated with a customer, and receive or retrieve a plurality of transactions comprising associated text data. The system may further dynamically determine, using a first machine learning model, a repeating source of deposits by identifying from among the plurality of transactions a portion of the text data that repeats and corresponds to one or more credits, dynamically generate, using a second machine learning model, an income amount and a confidence score based on the repeating source of deposits and the estimated income amount, dynamically generate a graphical user interface comprising the income amount and the confidence score, and dynamically transmit the graphical user interface to a second user device for display.

Disclosed embodiments may include a system for validating dynamic income. The system may include one or more processors, and memory in communication with the one or more processors and storing instructions that, when executed by the one or more processors, are configured to cause the system to validate dynamic income. The system may receive or retrieve a plurality of transactions comprising associated text data, dynamically determine, using a first machine learning model, a repeating source of deposits by identifying from among the plurality of transactions a portion of the text data that repeats and corresponds to one or more credits, dynamically generate, using a second machine learning model, an income amount based on the repeating source of deposits, dynamically generate a graphical user interface comprising the income amount, and dynamically transmit the graphical user interface to a second user device for display.

Disclosed embodiments may include a method for validating dynamic income. The method may include receiving, via a user device, an estimated income amount associated with a customer, receiving or retrieving a plurality of transactions comprising associated text data, dynamically determining, using a first machine learning model, a repeating source of deposits by identifying from among the plurality of transactions a portion of the text data that repeats and corresponds to one or more credits, dynamically generating, using a second machine learning model, an income amount based on the repeating source of deposits and the estimated income amount, dynamically generating a graphical user interface comprising the income amount and the estimated income amount, and dynamically transmitting the graphical user interface to a second user device for display.

Further implementations, features, and aspects of the disclosed technology, and the advantages offered thereby, are described in greater detail hereinafter, and can be understood with reference to the following detailed description, accompanying drawings, and claims.

### BRIEF DESCRIPTION OF THE DRAWINGS

Reference will now be made to the accompanying drawings, which are not necessarily drawn to scale, and which illustrate various implementations, aspects, and principles of the disclosed technology. In the drawings:

FIG. 1 is a flow diagram illustrating an exemplary method for validating dynamic income in accordance with certain embodiments of the disclosed technology.

FIG. 2 is block diagram of an example dynamic income verification system used to provide validating dynamic income, according to an example implementation of the disclosed technology.

FIG. 3 is block diagram of an example system that may be used to provide validating dynamic income, according to an example implementation of the disclosed technology.

### DETAILED DESCRIPTION

Examples of the present disclosure related to systems and methods for validating dynamic income. More particularly, the disclosed technology relates to generating and providing for display in a GUI an income amount and confidence score for a customer's income that is validated dynamically using optical character recognition (OCR) and machine learning models (MLM). The systems and methods described herein utilize, in some instances, machine learning models, which are necessarily rooted in computers and technology. Machine learning models are a unique computer technology that involves training models to complete tasks and make decisions. The present disclosure details generating and providing for display, via a GUI, an income amount and a confidence score of a customer's income for a company that validates dynamic income by using optical character recognition coupled with machine learning models. This, in some examples, may involve using income data or text data (e.g. bank statements) and estimated income amounts from the customer as input data and a machine learning model, applied and trained to analyze a plurality of transactions comprising associated text data, and outputs a result of the income amount and the confidence score. Using a machine learning model in this way may allow the system to generate an accurate income amount and a confidence score to determine if the customer receives a reliable income for lending purposes.

The systems and methods described herein utilize, in some instances, GUI, which are necessarily rooted in computers and technology. Graphical user interfaces are a computer technology that allows for user interaction with computers through touch, pointing devices, or other means. The present disclosure details generating and providing for display in a GUI an income amount and a confidence score for a customer's income that is validated dynamically. This, in some examples, may involve using transactions or text data (e.g. bank statements) and estimated income amounts from the customer as input data to dynamically change the graphical user interface as additional information is generated so that the GUI displays updated results (e.g., income amounts and confidence scores), which involves using specialized computer components that is configured to perform a specific task. Using a graphical user interface in this way may allow the system to provide a lender or other user with dynamic income informing both the user and the lender of options for funding based on the customer's income.

These are clear advantages and improvements over prior technologies that rely on slow results that must be manually generated by parsing through transactions or text data and calculating an income amount after analyzing the text in the text data. The present disclosure solves this problem by dynamically verifying income by determining a repeating source of deposits by identifying from among the plurality of transactions a portion of the text data that repeats and generating an income amount and confidence score based on the repeating source of deposits. Furthermore, examples of the present disclosure may also improve the speed with which computers can generate income amounts and confidence scores based on the income amounts and estimated income amounts. Overall, the systems and methods disclosed have significant practical applications in the computing technology field because of the noteworthy improvements of the machine learning model using dynamic data inputs to dynamically verify income, which are important to solving present problems with this technology.

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive. Many suitable components that would perform the same or similar functions as components described herein are intended to be embraced within the scope of the disclosed electronic devices and methods.

Reference will now be made in detail to example embodiments of the disclosed technology that are illustrated in the accompanying drawings and disclosed herein. Wherever convenient, the same reference numbers will be used throughout the drawings to refer to the same or like parts.

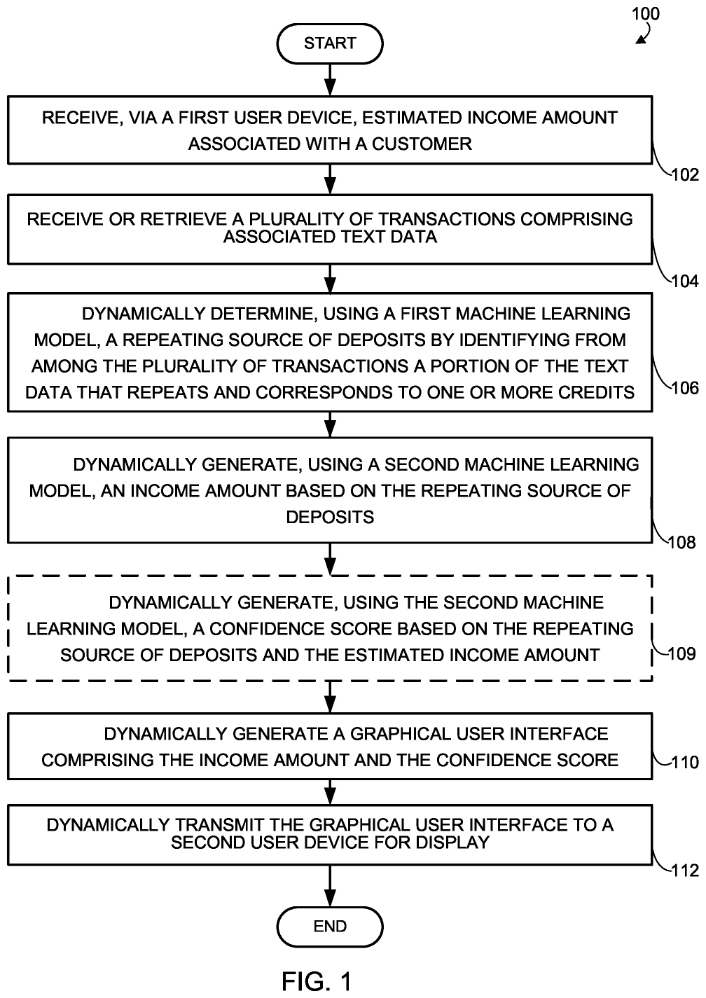

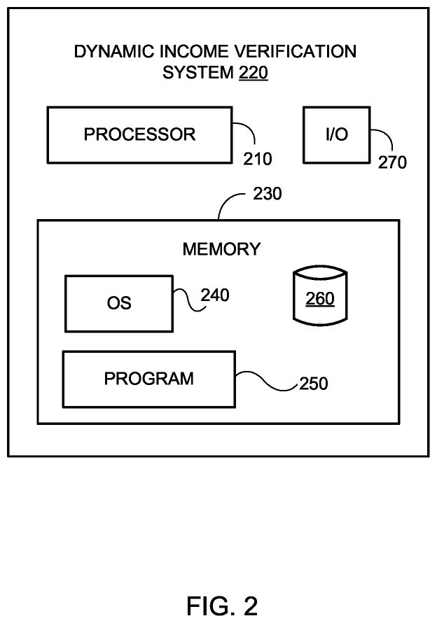

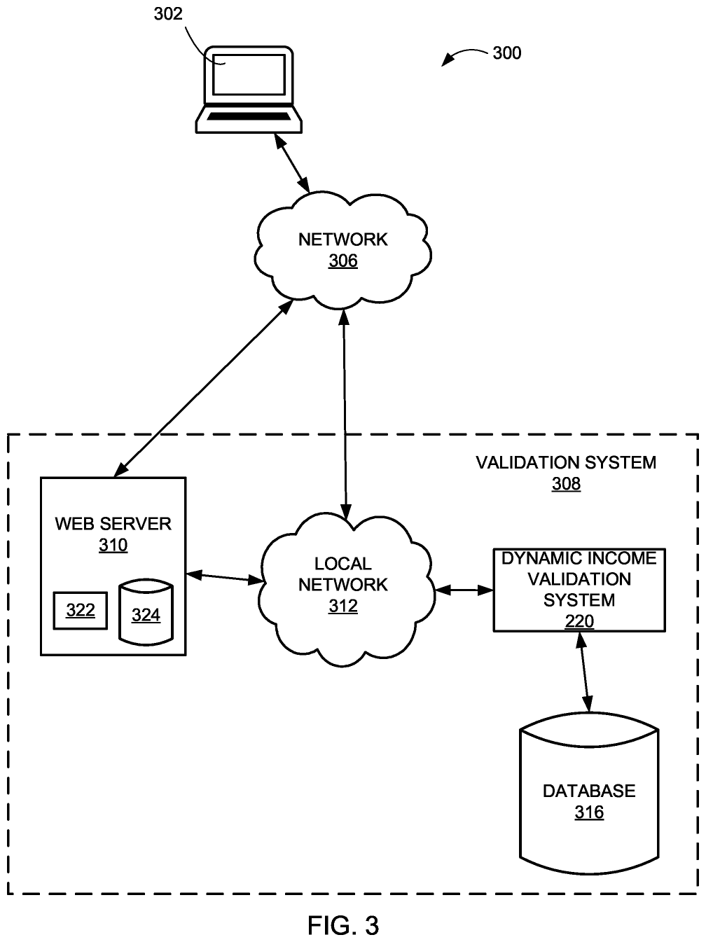

FIG. 1 is a flow diagram illustrating an exemplary method 100 for validating dynamic income, in accordance with certain embodiments of the disclosed technology. The steps of method 100 may be performed by one or more components of the system 300 (e.g., dynamic income verification system 220 or web server 310 of validation system 308 or user device 302), as described in more detail with respect to FIGS. 2 and 3.

In block 102, the dynamic income verification system 220 may receive, via a first user device, an estimated income amount associated with a customer. The text data and estimated income amount can be received via a user device. The text data may include a first name, last name, identity number, transactions, transaction values, or combinations thereof. For example, a bank statement from the user can include the first name and the last name of the customer along with their identity number. The user can also send a first name, last name, identity number, transactions, transaction values via the user device. The bank statement may also include one or more transactions, each transaction having a transaction value. The transaction can also include a source or other transaction identifying information. Other transaction identifying information can include an address for the source or an identifying number for the source. The transaction value can be positive or negative and can begin with a dollar sign ($) or can begin with a digit. The estimated income amount can be an income figure the user submits that represents what the user believes is their annual income amount. The estimated income amount can be an estimated annual income amount, an estimated monthly income amount, or an estimated weekly income amount. The estimated income amount can be received from the user via the user device.

In block 104, the dynamic income verification system 220 may receive or retrieve a plurality of transactions comprising associated text data. The dynamic income verification system 220 may retrieve the plurality of transactions from a database. The dynamic income verification system 220 may also receive the plurality of transactions from the first user device. In some embodiments, the dynamic income verification system 220 extracts text data from the plurality of transactions by performing optical character recognition on the plurality of transactions. The optical character recognition can be performed on the plurality of transactions or on text data (e.g. bank statements) to determine the numbers, letters, or symbols on the bank statement. The text data can include transactions from bank statements. The transactions can include a source, a transaction amount, and other transaction information. The text data (e.g. bank statements) may include a first name, last name, identity number, transactions, transaction values, or combinations thereof.

In block 106, the dynamic income verification system 220 may dynamically determine, using a first machine learning model, a repeating source of deposits by identifying from among the plurality of transactions a portion of the text data that repeats and corresponds to one or more credits. The dynamic income verification system 220 may utilize a machine learning model, such as one described below, to determine which portion of the text data repeats and corresponds to one or more credits. Transactions can have a negative or positive value which indicates the transaction is a debit or a credit. The text data can include one or more credits and one or more debits. A debit is transaction with a negative transaction value. A credit is a transaction with a positive transaction value. The first machine learning model can determine if text data corresponds to one or more credits and one or more debits by analyzing the list of characters in the text data to differentiate any dollar symbols ($) in the list of characters. Each dollar symbol ($) can correlate to a transaction value of a transaction. The first machine learning model may differentiate between credits and debits by separating lines in the text data by locating dollar symbols ($). The dynamic income verification system 220, using the first machine learning model, may identify a repeating source of deposits from among the plurality of transactions, which can then help determine that the portion of the text data corresponds to one or more credits. When a source consistently deposits funds into an account and the transaction value has a positive transaction value, the dynamic income verification system 220 can determine that the portion of the text data with the repeating deposits from the same source correspond to one or more credits.

In block 108, the dynamic income verification system 220 may dynamically generate, using a second machine learning model, an income amount based on the repeating source of deposits. The dynamic income verification system 220 may utilize a second machine learning model, such as one described below, to generate an income amount based on the repeating source of deposits. The machine learning model may parse through the portions of the text data to identify if a credit corresponds to an income source. The machine learning model can parse through the portions of the text data corresponding to one or more credits or one or more debits to see if a transaction source is repeated. Repeated transactions sources may indicate an income source. A repeated transaction amount that is also a credit may indicate an income source as well. A transaction with a positive transaction value that has a transaction amount that is not repeated or a transaction source that is not repeated may not be an income source, and may correspond to a gift. A gift does not qualify as income and is not included in the calculations for an income amount. Credits are also analyzed to determine if they are a direct deposit or a different type of deposit. The dynamic income verification system 220 may determine a credit is income based on the income source. An income source can be a known merchant or payment source in the art (e.g. venmo, square cash, etc.). Once an income source is identified, the corresponding transaction value of the one or more credits for the income source can be used to calculate or generate an income amount. Any credits identified as gifts are not used in the calculations to generate the income amount. If a credit cannot be classified as coming from an income source or as a gift, the dynamic income verification system 220 can use a flagging mechanism to flag the credit for review by a human. The credit can also be flagged to use later in the generation of a confidence score.

In block 109, the dynamic income verification system 220 may dynamically generate, using the second machine learning model, a confidence score based on the repeating source of deposits and the estimated income amount. The dynamic income verification system 220 may utilize the second machine learning model, such as one described below, to generate a confidence score based on the text data in the plurality of transactions corresponding to the one or more credits and the estimated income amount. The confidence score may be low, neutral or high. In some embodiments, the confidence score may be a figure between a predetermined range. Predetermined sub-ranges within the predetermined range can be classified as a low confidence score, neutral confidence score, or a high confidence score. The confidence score may be generated based on the text data corresponding to one or more credits and the estimated income amount. The confidence score may be generated using the flagged credits as described above. The dynamic income verification system 220 may determine that additional text data (e.g. additional bank statements) is necessary to generate an accurate income amount, which can result in a low confidence score. The dynamic income verification system 220 may determine that no additional text data (e.g. additional bank statements) is necessary to generate an accurate income amount, which can result in a high confidence score. When there are one or more credits that are identified by the repeating source of deposits, the confidence score can be high or low depending on the frequency of the deposits from the repeating source of deposits. If the frequency of deposits from the repeating source of deposits is high (e.g., above a first dynamically set threshold, which the dynamic income verification system 220 may set the first dynamically set threshold using the second machine learning model, initial training data, and/or feedback data), the dynamic income verification system 220 may determine that the confidence score should be high. If the frequency of deposits from the repeating source of deposits is low (e.g., below a second dynamically set threshold, the dynamic income system 220 may also set the second dynamically set threshold using the second machine learning model), the dynamic income verification system 220 may determine that the confidence score should be low. If the frequency of deposits from the repeating source of deposits is medium (e.g., between the first and second dynamically set thresholds), the dynamic income verification system 220 may determine that the confidence score should be medium. If there are no deposits from a repeating source of deposits, the dynamic income verification system 220 may determine that the confidence score should be high, medium, or low based on other factors. The first and second thresholds may be predetermined in some embodiments.

The dynamic income verification system 220 may determine that the generated income amount is not within a predetermined distance away from the estimated income amount and may generate a low confidence score. The dynamic income verification system 220 may determine that the generated income amount is within a predetermined distance away from the estimated income amount and may generate a high confidence score. The dynamic income verification system 220 may generate a low confidence score if an income source of a credit is from a predetermined untrustworthy income source. The dynamic income verification system 220 may generate a high confidence score if an income source of a credit is from a predetermined trustworthy income source. If a predetermined amount of credits are flagged for review, the dynamic income verification system 220 may generate a low confidence score. If a predetermined amount of credits are not flagged for review, the dynamic income verification system 220 may generate a high confidence score. In some embodiments, the dynamic income verification system 220 may also receive additional text data from the user via the user device. The additional text data may include income sources along with income amounts received from the income sources. The additional text data can be compared to the flagged credits to determine if a high or low confidence score should be generated. If the transaction values of the flagged credits do not correspond to any of the income amounts or add up to with other credits to the income amounts in the additional text data, then a low confidence score can be given. If the transaction values of the flagged credits do correspond to any of the income amounts or add up to with other credits to the income amounts in the additional text data, then a high confidence score can be given. Any of these methods of generating a high or low confidence score can be combined or used by itself by the dynamic income verification system 220 to generate the confidence score. In some examples, a high or low confidence score may result in the text data of the user being flagged for manual review. In other embodiments, a low or high confidence score may result in a recommendation regarding a new credit policy. A new credit policy can include a different annual percentage rate (APR). A recommendation for a new credit policy can result in the text data of the user being flagged for manual review. The first machine learning model and second machine learning model used by the dynamic income verification system 220 can be trained using past transactions or text data (e.g. bank statements). After the first machine learning model and the second machine learning model parse through the text data, classify transactions as credits and debits, identify repeating source of deposits, flags transactions for review, or generate an income amount or confidence score as described above, additional data can be provided to the first machine learning model and the second machine learning model to correct any identified errors in the results of the first machine learning model and the second machine learning model.

In block 110, the dynamic income verification system 220 may dynamically generate a GUI comprising the income amount and the confidence score. In some embodiments, the dynamic income verification system 220 may generate a GUI comprising only the income amount or only the confidence score. In some embodiments, the dynamic income verification system 220 may generate a GUI with any of the information received from the user device, such as the estimated income amount, the text data, the additional text data, or any combinations thereof. The dynamic income verification system 220 may also generate a GUI with any of the information in the text data, such as the first name, last name, identity number, transactions, transaction values, or combinations thereof.

In block 112, the dynamic income verification system 220 may dynamically transmit the GUI to a second user device for display. In some embodiments, the dynamic income verification system 220 may prompt the user for additional text data after transmitting the GUI to the second user device for display. In some embodiments, the dynamic income verification system 220 may determine whether the confidence score is below a predetermined threshold and in response to determining that the confidence score is below the predetermined threshold, the dynamic income verification system 220 may generate an updated GUI comprising the income amount, the confidence score, and a flag. The dynamic income verification system 220 may then transmit the updated GUI to the second user device for display.

FIG. 2 is a block diagram of an example dynamic income verification system 220 used to generate an income amount and a confidence score according to an example implementation of the disclosed technology. According to some embodiments, the user device 302 and web server 310, as depicted in FIG. 3 and described below, may have a similar structure and components that are similar to those described with respect to dynamic income verification system 220 shown in FIG. 2. As shown, the dynamic income verification system 220 may include a processor 210, an input/output (I/O) device 270, a memory 230 containing an operating system (OS) 240 and a program 250. In certain example implementations, the dynamic income verification system 220 may be a single server or may be configured as a distributed computer system including multiple servers or computers that interoperate to perform one or more of the processes and functionalities associated with the disclosed embodiments. In some embodiments dynamic income verification system 220 may be one or more servers from a serverless or scaling server system. In some embodiments, the dynamic income verification system 220 may further include a peripheral interface, a transceiver, a mobile network interface in communication with the processor 210, a bus configured to facilitate communication between the various components of the dynamic income verification system 220, and a power source configured to power one or more components of the dynamic income verification system 220.

A peripheral interface, for example, may include the hardware, firmware and/or software that enable(s) communication with various peripheral devices, such as media drives (e.g., magnetic disk, solid state, or optical disk drives), other processing devices, or any other input source used in connection with the disclosed technology. In some embodiments, a peripheral interface may include a serial port, a parallel port, a general-purpose input and output (GPIO) port, a game port, a universal serial bus (USB), a micro-USB port, a high-definition multimedia interface (HDMI) port, a video port, an audio port, a Bluetooth™4 port, a near-field communication (NFC) port, another like communication interface, or any combination thereof.

In some embodiments, a transceiver may be configured to communicate with compatible devices and ID tags when they are within a predetermined range. A transceiver may be compatible with one or more of: radio-frequency identification (RFID), near-field communication (NFC), Bluetooth™, low-energy Bluetooth™ (BLE), WiFi™, ZigBee™, ambient backscatter communications (ABC) protocols or similar technologies.

A mobile network interface may provide access to a cellular network, the Internet, or another wide-area or local area network. In some embodiments, a mobile network interface may include hardware, firmware, and/or software that allow(s) the processor(s) 210 to communicate with other devices via wired or wireless networks, whether local or wide area, private or public, as known in the art. A power source may be configured to provide an appropriate alternating current (AC) or direct current (DC) to power components.

The processor 210 may include one or more of a microprocessor, microcontroller, digital signal processor, co-processor or the like or combinations thereof capable of executing stored instructions and operating upon stored data. The memory 230 may include, in some implementations, one or more suitable types of memory (e.g. such as volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like), for storing files including an operating system, application programs (including, for example, a web browser application, a widget or gadget engine, and or other applications, as necessary), executable instructions and data. In one embodiment, the processing techniques described herein may be implemented as a combination of executable instructions and data stored within the memory 230.

The processor 210 may be one or more known processing devices, such as, but not limited to, a microprocessor from the Core™ family manufactured by Intel™, the Ryzen™ family manufactured by AMD™, or a system-on-chip processor using an ARM™ or other similar architecture. The processor 210 may constitute a single core or multiple core processor that executes parallel processes simultaneously, a central processing unit (CPU), an accelerated processing unit (APU), a graphics processing unit (GPU), a microcontroller, a digital signal processor (DSP), a field-programmable gate array (FPGA), an application-specific integrated circuit (ASIC) or another type of processing component. For example, the processor 210 may be a single core processor that is configured with virtual processing technologies. In certain embodiments, the processor 210 may use logical processors to simultaneously execute and control multiple processes. The processor 210 may implement virtual machine (VM) technologies, or other similar known technologies to provide the ability to execute, control, run, manipulate, store, etc. multiple software processes, applications, programs, etc. One of ordinary skill in the art would understand that other types of processor arrangements could be implemented that provide for the capabilities disclosed herein.

In accordance with certain example implementations of the disclosed technology, the dynamic income verification system 220 may include one or more storage devices configured to store information used by the processor 210 (or other components) to perform certain functions related to the disclosed embodiments. In one example, the dynamic income verification system 220 may include the memory 230 that includes instructions to enable the processor 210 to execute one or more applications, such as server applications, network communication processes, and any other type of application or software known to be available on computer systems. Alternatively, the instructions, application programs, etc. may be stored in an external storage or available from a memory over a network. The one or more storage devices may be a volatile or non-volatile, magnetic, semiconductor, tape, optical, removable, non-removable, or other type of storage device or tangible computer-readable medium.

The dynamic income verification system 220 may include a memory 230 that includes instructions that, when executed by the processor 210, perform one or more processes consistent with the functionalities disclosed herein. Methods, systems, and articles of manufacture consistent with disclosed embodiments are not limited to separate programs or computers configured to perform dedicated tasks. For example, the dynamic income verification system 220 may include the memory 230 that may include one or more programs 250 to perform one or more functions of the disclosed embodiments. For example, in some embodiments, the dynamic income verification system 220 may additionally manage dialogue and/or other interactions with the customer via a program 250.

The processor 210 may execute one or more programs 250 located remotely from the dynamic income verification system 220. For example, the dynamic income verification system 220 may access one or more remote programs that, when executed, perform functions related to disclosed embodiments.

The memory 230 may include one or more memory devices that store data and instructions used to perform one or more features of the disclosed embodiments. The memory 230 may also include any combination of one or more databases controlled by memory controller devices (e.g., server(s), etc.) or software, such as document management systems, Microsoft™ SQL databases, SharePoint™ databases, Oracle™ databases, Sybase™ databases, or other relational or non-relational databases. The memory 230 may include software components that, when executed by the processor 210, perform one or more processes consistent with the disclosed embodiments. In some embodiments, the memory 230 may include a dynamic income verification system database 260 for storing related data to enable the dynamic income verification system 220 to perform one or more of the processes and functionalities associated with the disclosed embodiments.

The dynamic income verification system database 260 may include stored data relating to status data (e.g., average session duration data, location data, idle time between sessions, and/or average idle time between sessions) and historical status data. According to some embodiments, the functions provided by the dynamic income verification system database 260 may also be provided by a database that is external to the dynamic income verification system 220, such as the database 316 as shown in FIG. 3.

The dynamic income verification system 220 may also be communicatively connected to one or more memory devices (e.g., databases) locally or through a network. The remote memory devices may be configured to store information and may be accessed and/or managed by the dynamic income verification system 220. By way of example, the remote memory devices may be document management systems, Microsoft™ SQL database, SharePoint™ databases, Oracle™ databases, Sybase™ databases, or other relational or non-relational databases. Systems and methods consistent with disclosed embodiments, however, are not limited to separate databases or even to the use of a database.

The dynamic income verification system 220 may also include one or more I/O devices 270 that may comprise one or more interfaces for receiving signals or input from devices and providing signals or output to one or more devices that allow data to be received and/or transmitted by the dynamic income verification system 220. For example, the dynamic income verification system 220 may include interface components, which may provide interfaces to one or more input devices, such as one or more keyboards, mouse devices, touch screens, track pads, trackballs, scroll wheels, digital cameras, microphones, sensors, and the like, that enable the dynamic income verification system 220 to receive data from a user (such as, for example, via the user device 302).

In examples of the disclosed technology, the dynamic income verification system 220 may include any number of hardware and/or software applications that are executed to facilitate any of the operations. The one or more I/O interfaces may be utilized to receive or collect data and/or user instructions from a wide variety of input devices. Received data may be processed by one or more computer processors as desired in various implementations of the disclosed technology and/or stored in one or more memory devices.

The dynamic income verification system 220 may contain programs that train, implement, store, receive, retrieve, and/or transmit one or more machine learning models. Machine learning models may include a neural network model, a generative adversarial model (GAN), a recurrent neural network (RNN) model, a deep learning model (e.g., a long short-term memory (LSTM) model), a random forest model, a convolutional neural network (CNN) model, a support vector machine (SVM) model, logistic regression, XGBoost, and/or another machine learning model. Models may include an ensemble model (e.g., a model comprised of a plurality of models). In some embodiments, training of a model may terminate when a training criterion is satisfied. Training criterion may include a number of epochs, a training time, a performance metric (e.g., an estimate of accuracy in reproducing test data), or the like. The dynamic income verification system 220 may be configured to adjust model parameters during training. Model parameters may include weights, coefficients, offsets, or the like. Training may be supervised or unsupervised.

The dynamic income verification system 220 may be configured to train machine learning models by optimizing model parameters and/or hyperparameters (hyperparameter tuning) using an optimization technique, consistent with disclosed embodiments. Hyperparameters may include training hyperparameters, which may affect how training of the model occurs, or architectural hyperparameters, which may affect the structure of the model. An optimization technique may include a grid search, a random search, a gaussian process, a Bayesian process, a Covariance Matrix Adaptation Evolution Strategy (CMA-ES), a derivative-based search, a stochastic hill-climb, a neighborhood search, an adaptive random search, or the like. The dynamic income verification system 220 may be configured to optimize statistical models using known optimization techniques.

Furthermore, dynamic income verification system 220 may include programs configured to retrieve, store, and/or analyze properties of data models and datasets. For example, the dynamic income verification system 220 may include or be configured to implement one or more data-profiling models. A data-profiling model may include machine learning models and statistical models to determine the data schema and/or a statistical profile of a dataset (e.g., to profile a dataset), consistent with disclosed embodiments. A data-profiling model may include an RNN model, a CNN model, or other machine-learning model.

The dynamic income verification system 220 may include algorithms to determine a data type, key-value pairs, row-column data structure, statistical distributions of information such as keys or values, or other property of a data schema may be configured to return a statistical profile of a dataset (e.g., using a data-profiling model). The dynamic income verification system 220 may be configured to implement univariate and multivariate statistical methods. The dynamic income verification system 220 may include a regression model, a Bayesian model, a statistical model, a linear discriminant analysis model, or other classification model configured to determine one or more descriptive metrics of a dataset. For example, dynamic income verification system 220 may include algorithms to determine an average, a mean, a standard deviation, a quantile, a quartile, a probability distribution function, a range, a moment, a variance, a covariance, a covariance matrix, a dimension and/or dimensional relationship (e.g., as produced by dimensional analysis such as length, time, mass, etc.) or any other descriptive metric of a dataset.

The dynamic income verification system 220 may be configured to return a statistical profile of a dataset (e.g., using a data-profiling model or other model). A statistical profile may include a plurality of descriptive metrics. For example, the statistical profile may include an average, a mean, a standard deviation, a range, a moment, a variance, a covariance, a covariance matrix, a similarity metric, or any other statistical metric of the selected dataset. In some embodiments, dynamic income verification system 220 may be configured to generate a similarity metric representing a measure of similarity between data in a dataset. A similarity metric may be based on a correlation, covariance matrix, a variance, a frequency of overlapping values, or other measure of statistical similarity.

The dynamic income verification system 220 may be configured to generate a similarity metric based on data model output, including data model output representing a property of the data model. For example, dynamic income verification system 220 may be configured to generate a similarity metric based on activation function values, embedding layer structure and/or outputs, convolution results, entropy, loss functions, model training data, or other data model output). For example, a synthetic data model may produce first data model output based on a first dataset and a produce data model output based on a second dataset, and a similarity metric may be based on a measure of similarity between the first data model output and the second-data model output. In some embodiments, the similarity metric may be based on a correlation, a covariance, a mean, a regression result, or other similarity between a first data model output and a second data model output. Data model output may include any data model output as described herein or any other data model output (e.g., activation function values, entropy, loss functions, model training data, or other data model output). In some embodiments, the similarity metric may be based on data model output from a subset of model layers. For example, the similarity metric may be based on data model output from a model layer after model input layers or after model embedding layers. As another example, the similarity metric may be based on data model output from the last layer or layers of a model.

The dynamic income verification system 220 may be configured to classify a dataset. Classifying a dataset may include determining whether a dataset is related to another datasets. Classifying a dataset may include clustering datasets and generating information indicating whether a dataset belongs to a cluster of datasets. In some embodiments, classifying a dataset may include generating data describing the dataset (e.g., a dataset index), including metadata, an indicator of whether data element includes actual data and/or synthetic data, a data schema, a statistical profile, a relationship between the test dataset and one or more reference datasets (e.g., node and edge data), and/or other descriptive information. Edge data may be based on a similarity metric. Edge data may and indicate a similarity between datasets and/or a hierarchical relationship (e.g., a data lineage, a parent-child relationship). In some embodiments, classifying a dataset may include generating graphical data, such as anode diagram, a tree diagram, or a vector diagram of datasets. Classifying a dataset may include estimating a likelihood that a dataset relates to another dataset, the likelihood being based on the similarity metric.

The dynamic income verification system 220 may include one or more data classification models to classify datasets based on the data schema, statistical profile, and/or edges. A data classification model may include a convolutional neural network, a random forest model, a recurrent neural network model, a support vector machine model, or another machine learning model. A data classification model may be configured to classify data elements as actual data, synthetic data, related data, or any other data category. In some embodiments, dynamic income verification system 220 is configured to generate and/or train a classification model to classify a dataset, consistent with disclosed embodiments.

The dynamic income verification system 220 may also contain one or more prediction models. Prediction models may include statistical algorithms that are used to determine the probability of an outcome, given a set amount of input data. For example, prediction models may include regression models that estimate the relationships among input and output variables. Prediction models may also sort elements of a dataset using one or more classifiers to determine the probability of a specific outcome. Prediction models may be parametric, non-parametric, and/or semi-parametric models.

In some examples, prediction models may cluster points of data in functional groups such as “random forests.” Random Forests may comprise combinations of decision tree predictors. (Decision trees may comprise a data structure mapping observations about something, in the “branch” of the tree, to conclusions about that thing's target value, in the “leaves” of the tree.) Each tree may depend on the values of a random vector sampled independently and with the same distribution for all trees in the forest. Prediction models may also include artificial neural networks. Artificial neural networks may model input/output relationships of variables and parameters by generating a number of interconnected nodes which contain an activation function. The activation function of a node may define a resulting output of that node given an argument or a set of arguments. Artificial neural networks may generate patterns to the network via an ‘input layer’, which communicates to one or more “hidden layers” where the system determines regressions via a weighted connections. Prediction models may additionally or alternatively include classification and regression trees, or other types of models known to those skilled in the art. To generate prediction models, the dynamic income verification system may analyze information applying machine-learning methods.

While the dynamic income verification system 220 has been described as one form for implementing the techniques described herein, other, functionally equivalent, techniques may be employed. For example, some or all of the functionality implemented via executable instructions may also be implemented using firmware and/or hardware devices such as application specific integrated circuits (ASICs), programmable logic arrays, state machines, etc. Furthermore, other implementations of the dynamic income verification system 220 may include a greater or lesser number of components than those illustrated.

FIG. 3 is a block diagram of an example system that may be used to view and interact with validation system 308, according to an example implementation of the disclosed technology. The components and arrangements shown in FIG. 3 are not intended to limit the disclosed embodiments as the components used to implement the disclosed processes and features may vary. As shown, validation system 308 may interact with a user device 302 via a network 306. In certain example implementations, the validation system 308 may include a local network 312, a dynamic income verification system 220, a web server 310, and a database 316.

In some embodiments, a user may operate the user device 302. The user device 302 can include one or more of a mobile device, smart phone, general purpose computer, tablet computer, laptop computer, telephone, public switched telephone network (PSTN) landline, smart wearable device, voice command device, other mobile computing device, or any other device capable of communicating with the network 306 and ultimately communicating with one or more components of the validation system 308. In some embodiments, the user device 302 may include or incorporate electronic communication devices for hearing or vision impaired users.

Users may include individuals such as, for example, subscribers, clients, prospective clients, or customers of an entity associated with an organization, such as individuals who have obtained, will obtain, or may obtain a product, service, or consultation from or conduct a transaction in relation to an entity associated with the validation system 308. According to some embodiments, the user device 302 may include an environmental sensor for obtaining audio or visual data, such as a microphone and/or digital camera, a geographic location sensor for determining the location of the device, an input/output device such as a transceiver for sending and receiving data, a display for displaying digital images, one or more processors, and a memory in communication with the one or more processors.

The network 306 may be of any suitable type, including individual connections via the internet such as cellular or WiFi networks. In some embodiments, the network 306 may connect terminals, services, and mobile devices using direct connections such as radio-frequency identification (RFID), near-field communication (NFC), Bluetooth™, low-energy Bluetooth™ (BLE), WiFi™, ZigBee™, ambient backscatter communications (ABC) protocols, USB, WAN, or LAN. Because the information transmitted may be personal or confidential, security concerns may dictate one or more of these types of connections be encrypted or otherwise secured. In some embodiments, however, the information being transmitted may be less personal, and therefore the network connections may be selected for convenience over security.

The network 306 may include any type of computer networking arrangement used to exchange data. For example, the network 306 may be the Internet, a private data network, virtual private network (VPN) using a public network, and/or other suitable connection(s) that enable(s) components in the system 300 environment to send and receive information between the components of the system 300. The network 306 may also include a PSTN and/or a wireless network.

The validation system 308 may be associated with and optionally controlled by one or more entities such as a business, corporation, individual, partnership, or any other entity that provides one or more of goods, services, and consultations to individuals such as customers. In some embodiments, the validation system 308 may be controlled by a third party on behalf of another business, corporation, individual, partnership. The validation system 308 may include one or more servers and computer systems for performing one or more functions associated with products and/or services that the organization provides.

Web server 310 may include a computer system configured to generate and provide one or more websites accessible to customers, as well as any other individuals involved in access system 308's normal operations. Web server 310 may include a computer system configured to receive communications from user device 302 via for example, a mobile application, a chat program, an instant messaging program, a voice-to-text program, an SMS message, email, or any other type or format of written or electronic communication. Web server 310 may have one or more processors 322 and one or more web server databases 324, which may be any suitable repository of website data. Information stored in web server 310 may be accessed (e.g., retrieved, updated, and added to) via local network 312 and/or network 306 by one or more devices or systems of system 300. In some embodiments, web server 310 may host websites or applications that may be accessed by the user device 302. For example, web server 310 may host a financial service provider website that a user device may access by providing an attempted login that are authenticated by the dynamic income verification system 220. According to some embodiments, web server 310 may include software tools, similar to those described with respect to user device 302 above, that may allow web server 310 to obtain network identification data from user device 302. The web server may also be hosted by an online provider of website hosting, networking, cloud, or backup services, such as Microsoft Azure™ or Amazon Web Services™.

The local network 312 may include any type of computer networking arrangement used to exchange data in a localized area, such as WiFi, Bluetooth™, Ethernet, and other suitable network connections that enable components of the validation system 308 to interact with one another and to connect to the network 306 for interacting with components in the system 300 environment. In some embodiments, the local network 312 may include an interface for communicating with or linking to the network 306. In other embodiments, certain components of the validation system 308 may communicate via the network 306, without a separate local network 306.

The validation system 308 may be hosted in a cloud computing environment (not shown). The cloud computing environment may provide software, data access, data storage, and computation. Furthermore, the cloud computing environment may include resources such as applications (apps), VMs, virtualized storage (VS), or hypervisors (HYP). User device 302 may be able to access validation system 308 using the cloud computing environment. User device 302 may be able to access validation system 308 using specialized software. The cloud computing environment may eliminate the need to install specialized software on user device 302.

In accordance with certain example implementations of the disclosed technology, the validation system 308 may include one or more computer systems configured to compile data from a plurality of sources the dynamic income verification system 220, web server 310, and/or the database 316. The dynamic income verification system 220 may correlate compiled data, analyze the compiled data, arrange the compiled data, generate derived data based on the compiled data, and store the compiled and derived data in a database such as the database 316. According to some embodiments, the database 316 may be a database associated with an organization and/or a related entity that stores a variety of information relating to customers, transactions, ATM, and business operations. The database 316 may also serve as a back-up storage device and may contain data and information that is also stored on, for example, database 260, as discussed with reference to FIG. 2.

Embodiments consistent with the present disclosure may include datasets. Datasets may comprise actual data reflecting real-world conditions, events, and/or measurements. However, in some embodiments, disclosed systems and methods may fully or partially involve synthetic data (e.g., anonymized actual data or fake data). Datasets may involve numeric data, text data, and/or image data. For example, datasets may include transaction data, financial data, demographic data, public data, government data, environmental data, traffic data, network data, transcripts of video data, genomic data, proteomic data, and/or other data. Datasets of the embodiments may be in a variety of data formats including, but not limited to, PARQUET, AVRO, SQLITE, POSTGRESQL, MYSQL, ORACLE, HADOOP, CSV, JSON, PDF. JPG, BMP, and/or other data formats.

Datasets of disclosed embodiments may have a respective data schema (e.g., structure), including a data type, key-value pair, label, metadata, field, relationship, view, index, package, procedure, function, trigger, sequence, synonym, link, directory, queue, or the like. Datasets of the embodiments may contain foreign keys, for example, data elements that appear in multiple datasets and may be used to cross-reference data and determine relationships between datasets. Foreign keys may be unique (e.g., a personal identifier) or shared (e.g., a postal code). Datasets of the embodiments may be “clustered.” for example, a group of datasets may share common features, such as overlapping data, shared statistical properties, or the like. Clustered datasets may share hierarchical relationships (e.g., data lineage).

### Example Use Case

The following example use case describes an example of a typical user flow pattern. This section is intended solely for explanatory purposes and not in limitation.

In one example, John decides to apply for a credit card from a credit card company. Company, the credit card company offers to provide John with a credit card, the credit card having a credit limit based on John's income. Company receives John's bank statements and an estimated income amount (e.g. $30,000) sent from John's computer. Thus, dynamic income verification system 220 receives, via a user device, text data and an estimated income amount associated with a customer. The dynamic income verification system 220 generates an income amount (e.g. $20,000) and a confidence score (e.g. 66% with 100% being the highest confidence that the customer income accuracy can be given) based on the bank statements and estimated income amount. The dynamic income verification system 220 generates a GUI comprising the income amount and the confidence score. Then, the dynamic income verification system 220 transmits the GUI to a computing device for display.

In some examples, disclosed systems or methods may involve one or more of the following clauses:

Clause 1: A dynamic income validation system comprising: one or more processors; memory in communication with the one or more processors and storing instructions that are configured to cause the dynamic income validation system to: receive, via a first user device, estimated income amount associated with a customer; receive or retrieve a plurality of transactions comprising associated text data; dynamically determine, using a first machine learning model, a repeating source of deposits by identifying from among the plurality of transactions a portion of the text data that repeats and corresponds to one or more credits; dynamically generate, using a second machine learning model, an income amount and a confidence score based on the repeating source of deposits and the estimated income amount; dynamically generate a graphical user interface comprising the income amount and the confidence score; and dynamically transmit the graphical user interface to a second user device for display.

Clause 2: The dynamic income validation system of clause 1, wherein receiving or retrieving the plurality of transactions further comprises: receiving, via the first user device, the plurality of transactions; and extracting the text data from the plurality of transactions by performing optical character recognition on the plurality of transactions.

Clause 3: The dynamic income validation system of clause 2, wherein the repeating source of deposits comprises repeating positive values.

Clause 4: The dynamic income validation system of clause 2, wherein the second machine learning model determines the confidence score based on a frequency of the repeating source of deposits.

Clause 5: The dynamic income validation system of clause 2, wherein determining the portion of the text data corresponds to the one or more credits comprises identifying direct deposits.

Clause 6: The dynamic income validation system of clause 2, wherein determining the portion of the text data corresponds to the one or more credits comprises identifying a known deposit source.

Clause 7: The dynamic income validation system of clause 1, wherein the memory stores further instructions that are configured to cause the system to: determine whether the confidence score is below a predetermined threshold; and responsive to determining that the confidence score is below the predetermined threshold: generate an updated graphical user interface comprising the income amount, the confidence score, and a flag; and transmit the updated graphical user interface to the second user device for display.

Clause 8: The dynamic income validation system of clause 1, wherein the memory stores further instructions that are configured to cause the system to: determine whether the estimated income amount is within a predetermined range of the income amount; and responsive to determining that the estimated income amount is not within the predetermined range of the income amount, modify the graphical user interface to comprise an indication that the estimated income amount is not accurate.

Clause 9: The dynamic income validation system of clause 1, wherein the memory stores further instructions that are configured to cause the system to: determine whether the estimated income amount is within a predetermined range of the income amount; and responsive to determining that the estimated income is within the predetermined range of the income amount, modify the graphical user interface to comprise an indication that the estimated income amount is accurate.

Clause 10: A dynamic income validation system comprising: one or more processors; memory in communication with the one or more processors and storing instructions that are configured to cause the dynamic income validation system to: receive or retrieve a plurality of transactions comprising associated text data; dynamically determine, using a first machine learning model, a repeating source of deposits by identifying from among the plurality of transactions a portion of the text data that repeats and corresponds to one or more credits; dynamically generate, using a second machine learning model, an income amount based on the repeating source of deposits; dynamically generate a graphical user interface comprising the income amount; and dynamically transmit the graphical user interface to a second user device for display.

Clause 11: The dynamic income validation system of clause 10, wherein the memory stores further instructions that are configured to cause the system to receive, via a first user device, estimated income amount associated with a customer.

Clause 12: The dynamic income validation system of clause 11, wherein receiving or retrieving a plurality of transactions further comprises: receiving, via the first user device, the plurality of transactions; and extracting the text data from the plurality of transactions by performing optical character recognition on the plurality of transactions.

Clause 13: The dynamic income validation system of clause 12, wherein the repeating source of deposits comprises repeating positive values.

Clause 14: The dynamic income validation system of clause 12, wherein the memory stores further instructions that are configured to cause the system to: generate, using a second machine learning model, a confidence score based on the portion of the text data corresponding to one or more credits identified by the repeating source of deposits, and an estimated income amount; determine whether the confidence score is below a predetermined threshold; and responsive to determining that the confidence score is below the predetermined threshold: generate an updated graphical user interface comprising the income amount, the confidence score, and a flag; and transmit the updated graphical user interface to the second user device for display.

Clause 15: The dynamic income validation system of clause 14, wherein determining the confidence score is based on a frequency of the repeating source of deposits.

Clause 16: The dynamic income validation system of clause 12, wherein the memory stores further instructions that are configured to cause the system to: determine whether an estimated income amount is within a predetermined range of the income amount; and responsive to determining that the estimated income amount is not within the predetermined range of the income amount, modify the graphical user interface to comprise an indication that the estimated income amount is not accurate.

Clause 17: The dynamic income validation system of clause 12, wherein the memory stores further instructions that are configured to cause the system to: generate, using the second machine learning model, a confidence score based on the income amount, an estimated amount, a frequency of credits in the text data, sources of credits in the text data, or combinations thereof; and responsive to generating the confidence score, modify the graphical user interface to further comprise the confidence score.

Clause 18: The dynamic income validation system of clause 17, wherein the memory stores further instructions that are configured to cause the system to: determine whether an estimated income amount is within a predetermined range of the income amount; and responsive to determining that the estimated income amount is within the predetermined range of the income amount, modify the graphical user interface to comprise an indication that the estimated income amount is accurate.

Clause 19: A computer implemented method comprising: receiving, via a user device, an estimated income amount associated with a customer; receiving or retrieving a plurality of transactions comprising associated text data; dynamically determining, using a first machine learning model, a repeating source of deposits by identifying from among the plurality of transactions a portion of the text data that repeats and corresponds to one or more credits; dynamically generating, using a second machine learning model, an income amount based on the repeating source of deposits and the estimated income amount; dynamically generating a graphical user interface comprising the income amount and the estimated income amount; and dynamically transmitting the graphical user interface to a second user device for display.

Clause 20: The method of clause 19, further comprising: generating, using the second machine learning model, a confidence score based on the income amount, the estimated income amount, a frequency of credits in the text data, sources of credits in the text data, a second frequency of deposits from the repeating source of deposits, or combinations thereof; and responsive to generating the confidence score, modifying the graphical user interface to further comprise the confidence score.

The features and other aspects and principles of the disclosed embodiments may be implemented in various environments. Such environments and related applications may be specifically constructed for performing the various processes and operations of the disclosed embodiments or they may include a general-purpose computer or computing platform selectively activated or reconfigured by program code to provide the necessary functionality. Further, the processes disclosed herein may be implemented by a suitable combination of hardware, software, and/or firmware. For example, the disclosed embodiments may implement general purpose machines configured to execute software programs that perform processes consistent with the disclosed embodiments. Alternatively, the disclosed embodiments may implement a specialized apparatus or system configured to execute software programs that perform processes consistent with the disclosed embodiments. Furthermore, although some disclosed embodiments may be implemented by general purpose machines as computer processing instructions, all or a portion of the functionality of the disclosed embodiments may be implemented instead in dedicated electronics hardware.

The disclosed embodiments also relate to tangible and non-transitory computer readable media that include program instructions or program code that, when executed by one or more processors, perform one or more computer-implemented operations. The program instructions or program code may include specially designed and constructed instructions or code, and/or instructions and code well-known and available to those having ordinary skill in the computer software arts. For example, the disclosed embodiments may execute high level and/or low-level software instructions, such as machine code (e.g., such as that produced by a compiler) and/or high-level code that can be executed by a processor using an interpreter.

The technology disclosed herein typically involves a high-level design effort to construct a computational system that can appropriately process unpredictable data. Mathematical algorithms may be used as building blocks for a framework, however certain implementations of the system may autonomously learn their own operation parameters, achieving better results, higher accuracy, fewer errors, fewer crashes, and greater speed.

As used in this application, the terms “component,” “module,” “system,” “server,” “processor,” “memory,” and the like are intended to include one or more computer-related units, such as but not limited to hardware, firmware, a combination of hardware and software, software, or software in execution. For example, a component may be, but is not limited to being, a process running on a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Certain embodiments and implementations of the disclosed technology are described above with reference to block and flow diagrams of systems and methods and/or computer program products according to example embodiments or implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some embodiments or implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, embodiments or implementations of the disclosed technology may provide for a computer program product, including a computer-usable medium having a computer-readable program code or program instructions embodied therein, said computer-readable program code adapted to be executed to implement one or more functions specified in the flow diagram block or blocks. Likewise, the computer program instructions may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Certain implementations of the disclosed technology described above with reference to user devices may include mobile computing devices. Those skilled in the art recognize that there are several categories of mobile devices, generally known as portable computing devices that can run on batteries but are not usually classified as laptops. For example, mobile devices can include, but are not limited to portable computers, tablet PCs, internet tablets, PDAs, ultra-mobile PCs (UMPCs), wearable devices, and smart phones. Additionally, implementations of the disclosed technology can be utilized with internet of things (IoT) devices, smart televisions and media devices, appliances, automobiles, toys, and voice command devices, along with peripherals that interface with these devices.

In this description, numerous specific details have been set forth. It is to be understood, however, that implementations of the disclosed technology may be practiced without these specific details. In other instances, well-known methods, structures, and techniques have not been shown in detail in order not to obscure an understanding of this description. References to “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form. By “comprising” or “containing” or “including” is meant that at least the named element, or method step is present in article or method, but does not exclude the presence of other elements or method steps, even if the other such elements or method steps have the same function as what is named.

It is to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

Although embodiments are described herein with respect to systems or methods, it is contemplated that embodiments with identical or substantially similar features may alternatively be implemented as systems, methods and/or non-transitory computer-readable media.

As used herein, unless otherwise specified, the use of the ordinal adjectives “first,” “second.” “third,” etc., to describe a common object, merely indicates that different instances of like objects are being referred to, and is not intended to imply that the objects so described must be in a given sequence, either temporally, spatially, in ranking, or in any other manner.

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A dynamic income validation system comprising:
one or more processors;
memory in communication with the one or more processors and storing instructions that are configured to cause the dynamic income validation system to:
receive, via a first user device, estimated income amount associated with a customer;
receive or retrieve a plurality of transactions comprising associated text data;
dynamically determine, using a first machine learning model, a repeating source of deposits by identifying from among the plurality of transactions a portion of the text data that repeats and corresponds to one or more credits;
dynamically generate, using a second machine learning model, an income amount and a confidence score based on the repeating source of deposits and the estimated income amount;
dynamically generate a graphical user interface comprising the income amount and the confidence score; and
dynamically transmit the graphical user interface to a second user device for display.

2. The dynamic income validation system of claim 1, wherein receiving or retrieving the plurality of transactions further comprises:
receiving, via the first user device, the plurality of transactions; and
extracting the text data from the plurality of transactions by performing optical character recognition on the plurality of transactions.

3. The dynamic income validation system of claim 2, wherein the repeating source of deposits comprises repeating positive values.

4. The dynamic income validation system of claim 2, wherein the second machine learning model determines the confidence score based on a frequency of the repeating source of deposits.

5. The dynamic income validation system of claim 2, wherein determining the portion of the text data corresponds to the one or more credits comprises identifying direct deposits.

6. The dynamic income validation system of claim 2, wherein determining the portion of the text data corresponds to the one or more credits comprises identifying a known deposit source.

7. The dynamic income validation system of claim 1, wherein the memory stores further instructions that are configured to cause the system to:
determine whether the confidence score is below a predetermined threshold; and
responsive to determining that the confidence score is below the predetermined threshold:
generate an updated graphical user interface comprising the income amount, the confidence score, and a flag; and
transmit the updated graphical user interface to the second user device for display.

8. The dynamic income validation system of claim 1, wherein the memory stores further instructions that are configured to cause the system to:
determine whether the estimated income amount is within a predetermined range of the income amount; and
responsive to determining that the estimated income amount is not within the predetermined range of the income amount, modify the graphical user interface to comprise an indication that the estimated income amount is not accurate.

9. The dynamic income validation system of claim 1, wherein the memory stores further instructions that are configured to cause the system to:
determine whether the estimated income amount is within a predetermined range of the income amount; and
responsive to determining that the estimated income is within the predetermined range of the income amount, modify the graphical user interface to comprise an indication that the estimated income amount is accurate.

10. A dynamic income validation system comprising:
one or more processors;
memory in communication with the one or more processors and storing instructions that are configured to cause the dynamic income validation system to:
receive or retrieve a plurality of transactions comprising associated text data;
dynamically determine, using a first machine learning model, a repeating source of deposits by identifying from among the plurality of transactions a portion of the text data that repeats and corresponds to one or more credits;
dynamically generate, using a second machine learning model, an income amount based on the repeating source of deposits;
dynamically generate a graphical user interface comprising the income amount; and
dynamically transmit the graphical user interface to a second user device for display.

11. The dynamic income validation system of claim 10, wherein the memory stores further instructions that are configured to cause the system to receive, via a first user device, estimated income amount associated with a customer.

12. The dynamic income validation system of claim 11, wherein receiving or retrieving a plurality of transactions further comprises:
receiving, via the first user device, the plurality of transactions; and
extracting the text data from the plurality of transactions by performing optical character recognition on the plurality of transactions.

13. The dynamic income validation system of claim 12, wherein the repeating source of deposits comprises repeating positive values.

14. The dynamic income validation system of claim 12, wherein the memory stores further instructions that are configured to cause the system to:
generate, using a second machine learning model, a confidence score based on the portion of the text data corresponding to one or more credits identified by the repeating source of deposits, and an estimated income amount;
determine whether the confidence score is below a predetermined threshold; and
responsive to determining that the confidence score is below the predetermined threshold:
generate an updated graphical user interface comprising the income amount, the confidence score, and a flag; and
transmit the updated graphical user interface to the second user device for display.

15. The dynamic income validation system of claim 14, wherein determining the confidence score is based on a frequency of the repeating source of deposits.

16. The dynamic income validation system of claim 12, wherein the memory stores further instructions that are configured to cause the system to:
determine whether an estimated income amount is within a predetermined range of the income amount; and
responsive to determining that the estimated income amount is not within the predetermined range of the income amount, modify the graphical user interface to comprise an indication that the estimated income amount is not accurate.

17. The dynamic income validation system of claim 12, wherein the memory stores further instructions that are configured to cause the system to:
generate, using the second machine learning model, a confidence score based on the income amount, an estimated amount, a frequency of credits in the text data, sources of credits in the text data, or combinations thereof; and
responsive to generating the confidence score, modify the graphical user interface to further comprise the confidence score.

18. The dynamic income validation system of claim 17, wherein the memory stores further instructions that are configured to cause the system to:
determine whether an estimated income amount is within a predetermined range of the income amount; and
responsive to determining that the estimated income amount is within the predetermined range of the income amount, modify the graphical user interface to comprise an indication that the estimated income amount is accurate.

19. A computer implemented method comprising:
receiving, via a user device, an estimated income amount associated with a customer;
receiving or retrieving a plurality of transactions comprising associated text data;
dynamically determining, using a first machine learning model, a repeating source of deposits by identifying from among the plurality of transactions a portion of the text data that repeats and corresponds to one or more credits;
dynamically generating, using a second machine learning model, an income amount based on the repeating source of deposits and the estimated income amount;
dynamically generating a graphical user interface comprising the income amount and the estimated income amount; and
dynamically transmitting the graphical user interface to a second user device for display.

20. The method of claim 19, further comprising:
generating, using the second machine learning model, a confidence score based on the income amount, the estimated income amount, a frequency of credits in the text data, sources of credits in the text data, a second frequency of deposits from the repeating source of deposits, or combinations thereof; and
responsive to generating the confidence score, modifying the graphical user interface to further comprise the confidence score.
